(19) United States
(12) Patent Application Publication
(10) Pub. No.: US 2026/0335985 A1
(43) Pub. Date: Oct. 29, 2026

(54) MACHINE TOOL CONTROL DEVICE AND MACHINE TOOL DISPLAY DEVICE

(71) Applicant: FANUC CORPORATION, Minamitsuru-gun, Yamanashi (JP)

(72) Inventor: Masashi YASUDA, Yamanashi (JP)

(73) Assignee: FANUC CORPORATION, Minamitsuru-gun, Yamanashi (JP)

(21) Appl. No.: 19/109,065

(22) PCT Filed: Sep. 30, 2022
(86) PCT No.: PCT/JP2022/036751

§ 371 Date: Mar. 5, 2025

(51) Int. Cl. B23B 27/14; G05B 19/18

(52) U.S. Cl. CPC B23B 27/143; G05B 19/182; G05B 2219/45044

(57) ABSTRACT

Provided is the technology that enables accurate assessment as to whether chip shredding is possible in oscillation cutting, even if machining conditions change, and that also facilitates adjustment of the machining conditions. A machine tool control device 1 comprises: a condition acquisition unit 11 that acquires, as preconditions, one or two items of information from among three items of information that are a feed amount F, an oscillation frequency multiplier I, and an oscillation amplitude multiplier K; an air cut amount acquisition unit 12 that acquires a designated air cut amount that indicates the degree of air cutting in a direction of oscillation; and a machining control unit 13 that, on the basis of the preconditions, determines the item(s) of information among the three items of information not acquired by the condition acquisition unit 11 so that an air cut amount based on an amount between n rotation passes and rotation passes subsequent to n rotations will be a designated air cut amount and performs machining control.

### TECHNICAL FIELD

The present disclosure relates to a control device for a machine tool and a display device for a machine tool.

### BACKGROUND ART

During machining, chips are continuously generated. It is known to perform machining while relatively oscillating a cutting tool and a workpiece in order to avoid a situation in which entanglement of the chips with the workpiece and the cutting tool or a similar behavior of the chips causes machining defects, machine failures, and the like.

In the oscillating machining of this type, a setting is made such that a tool path, which is a trajectory of the tool, partially overlaps with the previous tool path. As a result, the tool is caused to perform idle motion while being separate from the surface of the workpiece, which is called air cutting, whereby the chips are shredded (see, for example, Patent Documents 1 and 2).

### CITATION LIST

### Patent Document

Patent Document 1: Japanese Unexamined Patent Application, Publication No. 2018-094690
Patent Document 2: Japanese Unexamined Patent Application, Publication No. 2020-009248

### DISCLOSURE OF THE INVENTION

### Problems to be Solved by the Invention

Settings for the cutting are often determined based on an amplitude multiplying factor, which is a ratio of an amplitude to a feed amount of a tool per rotation of a spindle. In order to ensure that the tool performs the air cutting, the amplitude multiplying factor is set to a value having a slight margin, and not the limit of a range in which the tool performs the air cutting. For example, even in a case where the cutting tool theoretically performs the air cutting at an amplitude multiplying factor of 1.0, machining has conventionally been performed at an amplitude multiplying factor of 1, 2, which has a margin.

However, in a case of employing the method of determining an oscillation amplitude based on the amplitude multiplying factor, a difference in a feed rate enables or disables chip shredding even at the same amplitude multiplying factor. For taper machining, in a case where a feed rate is constant but a taper angle is large, since the feed rate in an oscillation direction is low, chip shredding variably becomes possible or impossible. Therefore, it is difficult to adjust the machining conditions.

In the first place, since a value of the amplitude multiplying factor necessary for enabling chip shredding varies depending on a value set as a frequency multiplying factor that indicates the number of oscillations per rotation of the spindle, the method of setting the amplitude multiplying factor is per se difficult to understand in relation to whether or not chip shredding is possible, which makes it difficult to adjust the machining conditions.

The present disclosure has been achieved in view of the above-described disadvantages, and an object of the present disclosure is to provide a technique pertaining to oscillating cutting, making it possible to accurately determine whether or not chip shredding is possible, and facilitating adjustment of a machining condition.

### Means for Solving the Problems

The present disclosure is directed to a control device for a machine tool that performs machining while relatively oscillating a cutting tool and a workpiece, the control device including: a condition acquisition unit configured to acquire, as a precondition, one or two pieces of information from among three pieces of information including information regarding a feed amount per relative rotation of the cutting tool and the workpiece, information regarding a number of oscillations per relative rotation of the cutting tool and the workpiece, and information regarding an oscillation amplitude with respect to the feed amount per relative rotation of the cutting tool and the workpiece; an air cutting amount acquisition unit configured to acquire a designated air cutting amount that indicates a degree of air cutting in an oscillation direction; and, a machining control unit configured to determine, based on the precondition, the information among the three pieces of information that is not acquired by the condition acquisition unit such that an air cutting amount based on an interval between a pass in an n-th rotation and a pass in a rotation subsequent to the n-th rotation becomes equal to the designated air cutting amount, the machining control unit being configured to perform machining control.

Furthermore, the present disclosure is directed to a display device for a machine tool that performs machining while relatively oscillating a cutting tool and a workpiece, the display device including: a condition input unit configured to receive, as a precondition, an input of one or two pieces of information from among three pieces of information including information regarding a feed amount per relative rotation of the cutting tool and the workpiece, information regarding a number of oscillations per relative rotation of the cutting tool and the workpiece, and information regarding an oscillation amplitude with respect to the feed amount per relative rotation of the cutting tool and the workpiece; an air cutting amount input unit configured to receive an input of a designated air cutting amount that indicates a degree of air cutting in an oscillation direction; an information calculation unit configured to calculate, based on the precondition, the information among the three pieces of information that is not received by the condition input unit such that an air cutting amount based on an interval between a pass in an n-th rotation and a pass in a rotation subsequent to the n-th rotation becomes equal to the designated air cutting amount; and a display unit configured to display the information calculated by the information calculation unit.

### Effects of the Invention

The present disclosure can provide a technique pertaining to oscillating cutting, making it possible to accurately determine whether or not chip shredding is possible, and facilitating adjustment of a machining condition.

### BRIEF DESCRIPTION OF THE DRAWINGS

FIG. 1 is a diagram for explaining oscillating cutting;

FIG. 2 is a functional block diagram of a control device for a machine tool according to a first embodiment;

FIG. 3 is a block diagram illustrating conditions acquired by a condition acquisition unit according to the first embodiment;

FIG. 4 illustrates an example of a machining program;

FIG. 5 is a diagram schematically illustrating a positional relationship between a workpiece and a cutting tool;

FIG. 6 is a block diagram illustrating conditions acquired by a condition acquisition unit according to a second embodiment;

FIG. 7 is a diagram schematically illustrating a positional relationship between a workpiece and a cutting tool when a taper angle is small;

FIG. 8 is a diagram schematically illustrating a positional relationship between a workpiece and a cutting tool when a taper angle is large;

FIG. 9 is a block diagram illustrating conditions acquired by a condition acquisition unit according to a third embodiment; and

FIG. 10 is a functional block diagram of a display device for a machine tool according to a modification.

### PREFERRED MODE FOR CARRYING OUT THE INVENTION

The following describes embodiments of the present disclosure in detail with reference to the drawings.

### First Embodiment

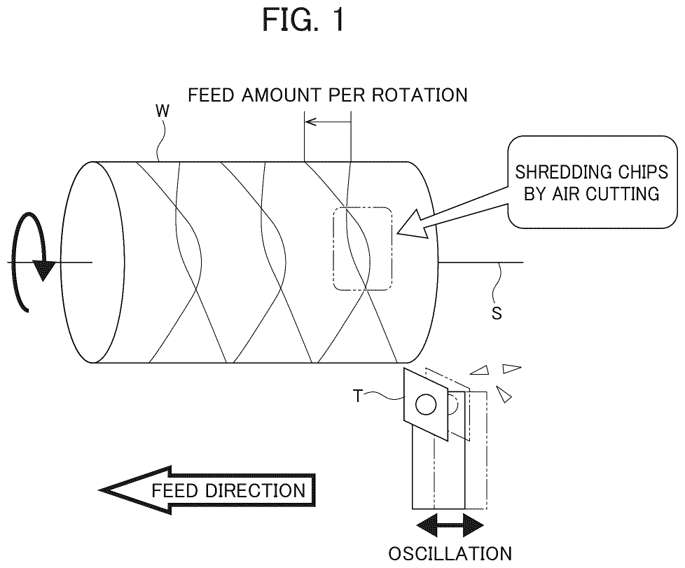

A control device 1 for a machine tool according to a first embodiment of the present invention is adapted for performing oscillating cutting (turning) in which a cutting tool cuts a workpiece while the cutting tool and the workpiece are relatively oscillated. First, the oscillating cutting will be described with reference to FIG. 1.

FIG. 1 is a diagram for explaining the oscillating cutting. In the example of the oscillating cutting illustrated in FIG. 1, at least one spindle S that relatively rotates the cutting tool T and the workpiece W and at least one feed shaft that moves the cutting tool T relative to the workpiece W are operated, so that cutting is performed while the cutting tool T and the workpiece W are relatively oscillated in a feed direction, concurrently with the relative rotation of the cutting tool T and the workpiece W. At this time, a setting is made on the tool path, which is the trajectory of the cutting tool T, such that the current path partially overlaps with the previous path. Specifically, since a portion machined in the previous path is partially included in the current path, the cutting edge of the cutting tool T is caused to perform idle motion while being separate from the surface of the workpiece W, which is called air cutting, whereby chips are shredded.

It should be noted that, for the oscillating cutting performed in the present embodiment, the workpiece is not limited to any shape. Specifically, the oscillating cutting according to the present embodiment is applicable to a case where a plurality of feed axes (a Z-axis and an X-axis) are necessary to machine a workpiece having a tapered portion or an arc-shaped portion on a surface thereof to be machined and a case where a specific single feed axis (a Z-axis) is sufficient to machine a workpiece having a circular columnar shape or a cylindrical shape.

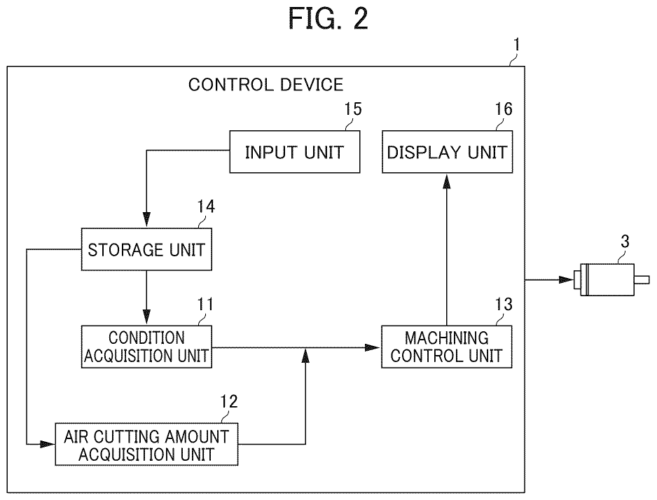

Next, a configuration of the control device 1 for a machine tool will be described. FIG. 2 is a functional block diagram of the control device 1 for a machine tool according to the present embodiment. The control device 1 for a machine tool is constituted by, for example, a computer including memories such as a read only memory (ROM) and a random access memory (RAM), a central processing unit (CPU), and a communication control unit, which are connected to each other via a bus. The functions and operations of the functional units are implemented by cooperation between the CPU and the memories incorporated in the computer and control programs stored in the memories. The control device 1 for a machine tool may be constituted by a computer numerical controller (CNC), a programmable logic controller (PLC), or the like. Alternatively, the control device 1 for a machine tool may be connected to a host computer that outputs, in addition to a machining program, machining conditions such as a rotation speed and the like. For the sake of convenience, FIG. 2 illustrates only a motor 3 that drives one feed shaft.

As illustrated in FIG. 2, the control device 1 for a machine tool includes a condition acquisition unit 11, an air cutting amount acquisition unit 12, a machining control unit 13, a storage unit 14, an input unit 15, and a display unit 16.

The condition acquisition unit 11 acquires a machining condition and an oscillation condition for performing oscillating machining on the workpiece W. The machining condition and the oscillation condition may be stored in the storage unit 14, or may be outputted from an external computer.

Here, the machining condition includes at least information regarding a feed amount per relative rotation of the cutting tool and the workpiece and information regarding a shape of a cutting edge of the cutting tool. In addition, the machining condition includes, for example, information regarding a rotation number S (1/min) of a spindle, a feed rate (mm/min) for the cutting tool, a workpiece radius (mm), a clearance angle (°) of the cutting tool, and the like. Examples of the information regarding a feed amount per relative rotation of the cutting tool and the workpiece include a feed amount F per rotation (mm/rev), a combination of a rotation number S (1/min) of the spindle and a feed rate (mm/min) of the cutting tool, and the like. An example of the information regarding the shape of the cutting edge of the cutting tool is the cutting edge R (mm).

The oscillation condition includes information regarding the number of oscillations per relative rotation of the cutting tool and the workpiece, and information regarding an oscillation amplitude with respect to the feed amount per relative rotation of the cutting tool and the workpiece. An example of the information regarding the number of oscillations per relative rotation of the cutting tool and the workpiece is an oscillation frequency multiplying factor I (times) that indicates an oscillation frequency per rotation of the spindle. An example of the information regarding the oscillation amplitude with respect to the feed amount per relative rotation of the cutting tool and the workpiece is an oscillation amplitude multiplying factor K (times) that indicates the magnitude of an oscillation amplitude with respect to the magnitude of a feed amount per rotation of the spindle. The oscillation frequency multiplying factor I (times) may be directly designated, or may be calculated from an oscillation frequency (Hz), which is designated beforehand, and a spindle rotation number S (1/min). Likewise, the oscillation amplitude multiplying factor K (times) may be directly designated, or may be calculated from an oscillation amplitude (mm), which is designated beforehand, a feed rate (mm/min), and a spindle rotation number S (1/min).

The air cutting amount acquisition unit 12 acquires a designated air cutting amount, which is designated in advance by an operator or the like. For example, the air cutting amount may be stored in the storage unit 14, may be acquired from an external computer, or may be inputted via the input unit 15.

The air cutting amount as used herein refers to an air cutting amount in the interval between a pass in an n-th rotation and a pass in a rotation subsequent to the n-th rotations (the (n+1)-th or subsequent rotation). In the present embodiment, the air cutting amount in the interval between the pass in the n-th rotation and the pass in the (n+1)-th rotation is used to determine the machining condition, but the present invention is not limited thereto. For example, an air cutting amount in the interval between the pass in the n-th rotation and the pass in the (n+2)-th rotation may be used to determine the machining condition.

In the present embodiment, a distance in an oscillation direction is used as the air cutting amount. In the present embodiment, the oscillation takes place in the feed direction of the feed shaft, and accordingly, the air cutting amount is a numerical value indicating a degree of air cutting in the feed direction. It is suitable that the air cutting amount is an indicator of the magnitude of the air cutting, and the air cutting amount may be a distance in the oscillation direction. Alternatively, the air cutting amount may be expressed by an area including the oscillation direction, a level associated with an air cutting amount determined in advance in a table, or a multiplying factor with respect to an arbitrary reference value (e.g., a workpiece radius, a feed amount, etc.).

The machining control unit 13 performs machining control based on the condition acquired by the condition acquisition unit 11 such that the air cutting amount after a start of machining becomes equal to the designated air cutting amount. The details of the machining control by the machining control unit 13 will be described later.

The storage unit 14 stores therein various kinds of information for controlling the machine tool and for performing machining. In the present embodiment, the storage unit 14 stores therein the machining condition, the oscillation condition, and the air cutting amount designated by the operator. The machining condition, the oscillation condition, and the air cutting amount are, for example, inputted to a machining program by the operator or designated as parameters of the machine tool. The storage unit 14 may be disposed outside the control device 1, instead of being disposed in the control device 1.

The input unit 15 inputs information regarding the machining, in response to the operator performing input operation on an input means (not shown) such as a keyboard or a touch panel. The information regarding the machining inputted by the input unit 15 is stored in the storage unit 14 and the like, or is inputted to each unit of the control device 1.

The display unit 16 displays various kinds of information regarding the machine tool, the control device 1, and the machining.

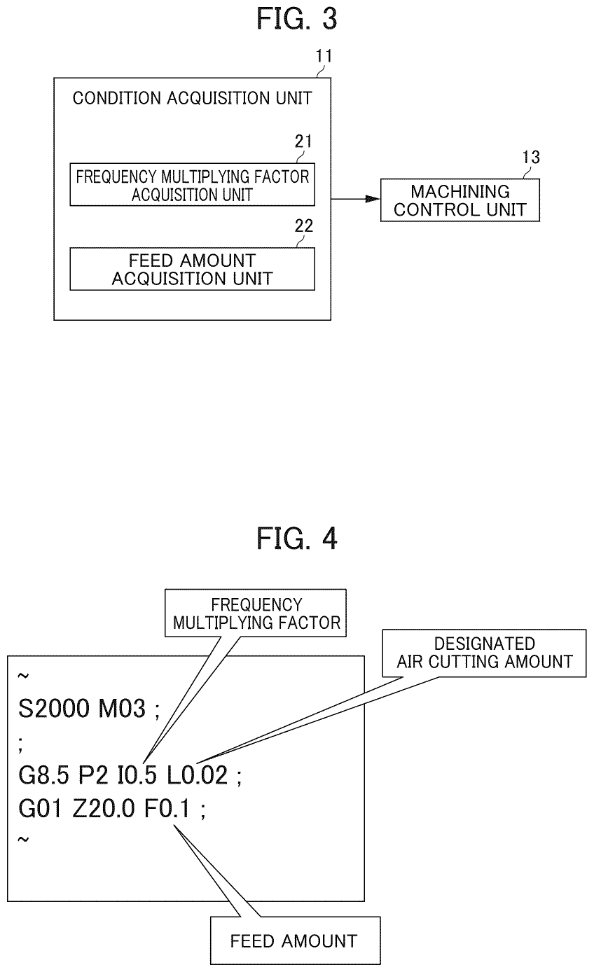

Next, conditions acquired by the condition acquisition unit 11 and the machining control performed by the machining control unit 13 will be described with reference to FIG. 3. FIG. 3 is a block diagram illustrating the conditions acquired by the condition acquisition unit 11 according to the first embodiment.

As illustrated in FIG. 3, the condition acquisition unit 11 includes a frequency multiplying factor acquisition unit 21 and a feed amount acquisition unit 22. The frequency multiplying factor acquisition unit 21 is an oscillation number acquisition unit for acquiring information regarding the number of oscillations per relative rotation of the cutting tool and the workpiece, and acquires the oscillation frequency multiplying factor I (times) as information regarding the number of oscillations. The feed amount acquisition unit 22 acquires the feed amount F (mm/rev) per rotation of the spindle as information regarding the feed amount per relative rotation of the cutting tool and the workpiece.

FIG. 4 illustrates an example of the machining program. The machining program illustrated in FIG. 4 contains various kinds of information designated by the operator via the input unit 15 or the like. In the machining program illustrated in FIG. 4, the block “S2000 M03” is a description indicating that the spindle is to be rotated forward. The block “G8.5 P2 I0.5 L0.02” includes “10.5” that indicates a frequency multiplying factor, and “L0.02” that indicates a designated air cutting amount. In the block “G01 Z20.0 F0.1”, “F0.1” is a description indicating a feed amount.

Upon a start of a machining operation, the condition acquisition unit 11 of the control device 1 acquires a frequency multiplying factor and a feed amount from the machining program, and the air cutting amount acquisition unit 12 acquires a designated air cutting amount. In the example illustrated in FIG. 4, the condition acquisition unit 11 acquires a frequency multiplying factor of 0.5 [times] from “10.5” and acquires a feed amount per rotation of 0.1 [mm/rev] from “F0.1”. The air cutting amount acquisition unit 12 acquires a designated air cutting amount of 0.02 [mm] from “L0.02”.

Based on the frequency multiplying factor and the feed amount, which are the condition acquired by the condition acquisition unit 11, and the designated air cutting amount, which is acquired by the air cutting amount acquisition unit 12, the machining control unit 13 determines an oscillation amplitude for performing oscillating cutting according to the following equation. In this example, a frequency multiplying factor of 0.5 [times], a feed amount per rotation of 0.1 [mm/rev], and a designated air cutting amount of 0.02 [mm] are substituted into the equation.

$$( F ( \frac{θ - 2 π}{2 π} ) + ( A \cdot cos ( I ( θ - 2 π ) ) - 1 ) ) ) - ( F ( \frac{θ}{2 π} ) + ( A \cdot cos ( I θ ) - 1 ) ) ) = L [ mm ] \qquad [ Eq . 1 ]$$

In Equation (1), I represents the frequency multiplying factor [times], F represents the feed amount per rotation [mm/rev], L represents the designated air cutting amount [mm], A represents the oscillation amplitude [mm], and 0 represents a workpiece phase [′] in which the air cutting amount L is achieved.

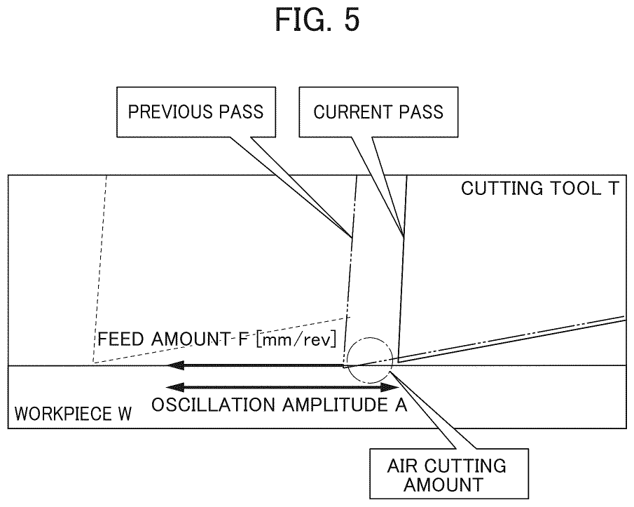

FIG. 5 is a diagram schematically illustrating a positional relationship between the workpiece W and the cutting tool T. As illustrated in FIG. 5, the machining control unit 13 performs the oscillating cutting based on the oscillation amplitude A calculated according to Equation (1) such that the air cutting amount in the interval between the previous pass that is the n-th cutting pass and the current pass that is the (n+1)-th cutting pass becomes equal to the designated air cutting amount.

The machining control unit 13 outputs information indicating the calculated oscillation amplitude to the display unit 16. The display unit 16 conveys the oscillation amplitude to the operator by means of character information indicating the oscillation amplitude, graphic information indicating the oscillation amplitude, a combination thereof, or the like.

According to the first embodiment described above, the control device 1 for a machine tool that performs machining while relatively oscillating a cutting tool T and a workpiece W exerts the following effects.

The control device 1 for a machine tool according to the present embodiment includes: a condition acquisition unit 11 that acquires, as a precondition, one or two pieces of information from among three pieces of information including information regarding a feed amount per relative rotation of the cutting tool T and the workpiece W (e.g., a feed amount F), information regarding the number of oscillations per relative rotation of the cutting tool T and the workpiece W (e.g., an oscillation frequency multiplying factor I), and information regarding an oscillation amplitude with respect to the feed amount per relative rotation of the cutting tool T and the workpiece (e.g., an oscillation amplitude multiplying factor K); an air cutting amount acquisition unit 12 that acquires a designated air cutting amount indicating a degree of air cutting in an oscillation direction; and a machining control unit 13 that determines, based on the precondition, the information among the three pieces of information that is not acquired by the condition acquisition unit 11 such that an air cutting amount based on an interval between a pass in an n-th rotation and a pass in a rotation subsequent to the n-th rotation becomes equal to the designated air cutting amount, the machining control unit 13 being configured to perform machining control. Due to this feature, since the designated air cutting amount is set as a target, even if the machining condition is changed during the oscillating cutting, it is possible to accurately determine whether or not chip shredding is possible, and adjustment of the machining condition can be facilitated.

The condition acquisition unit 11 of the present embodiment acquires, as the precondition, the information regarding the feed amount and the information regarding the number of oscillations from among the three pieces of information, and the machining control unit 13 determines the information regarding the oscillation amplitude based on the information regarding the feed amount and the information regarding the number of oscillations such that the air cutting amount based on the interval between the pass in the n-th rotation and the pass in the rotation subsequent to the n-th rotation ((n+1)-th rotation) becomes equal to the designated air cutting amount. In a case of employing the method of determining an oscillation amplitude by setting an oscillation amplitude multiplying factor as in the known art, a difference in a feed rate enables or disables chip shredding even at the same amplitude multiplying factor. For example, in a case where the frequency multiplying factor is 0.5 [times], the amplitude multiplying factor is 1.2 [times], and the feed amount is 0.04 [mm/rev], the theoretical air cutting amount is 8.0 [μm]. On the other hand, even though the frequency multiplying factor is 0.5 [times] and the amplitude multiplying factor is 1.2 [times], the theoretical air cutting amount becomes 2.0 [μm] when the feed amount is 0.01 [mm/rev]. In this respect, the control device 1 of the present embodiment calculates the oscillation amplitude based on the designated air cutting amount even when the feed amount changes, thereby making it possible to avoid a situation in which the result of determination on chip shredding varies due to a change in the feed amount.

The control device 1 of the present embodiment further includes a display unit 16 that outputs the information determined by the machining control unit 13. This feature allows an operator to easily check safety and a manufacture plan, based on the calculation result from the machining control unit 13 such as the oscillation amplitude.

Next, embodiments different from the first embodiment will be described. In the following description, components in common with the above-described embodiment are denoted by the same reference signs, and detailed description thereof may be omitted as appropriate.

### Second Embodiment

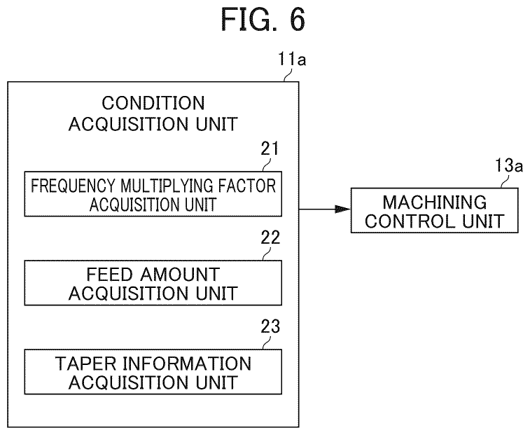

FIG. 6 is a block diagram illustrating conditions acquired by a condition acquisition unit 11a of a second embodiment. The control device 1 according to the second embodiment is the same as the control device 1 for a machine tool according to the first embodiment except for the conditions acquired by the condition acquisition unit 11a and the control method executed by a machining control unit 13a.

As illustrated in FIG. 6, the condition acquisition unit 11a includes a frequency multiplying factor acquisition unit 21, a feed amount acquisition unit 22, and a taper information acquisition unit 23.

The taper information acquisition unit 23 acquires taper information regarding a taper of a workpiece W from a storage unit 14. The taper information includes, for example, information regarding taper machining such as a movement direction of a cutting tool T and a taper angle that is a movement angle of the cutting tool T. The taper angle is, for example, an angle formed by a central axis and a surface of the workpiece W. The taper information may be described in a machining program in accordance with designation by an operator, or may be held as a parameter of the machine tool.

In a case of performing taper machining, the machining control unit 13a of the second embodiment changes the calculation of an oscillation amplitude in consideration of the magnitude of the taper angle. More specifically, the machining control unit 13a calculates the oscillation amplitude based on Fz that is a velocity component in a Z-axis direction of a feed amount F. The influence of the taper angle depends on how large or small the angle is. In the following, the calculation of Fz, which is the velocity component in the Z-axis direction of the feed amount F, will be described for each of the case where the taper angle is small and the case where the taper angle is large.

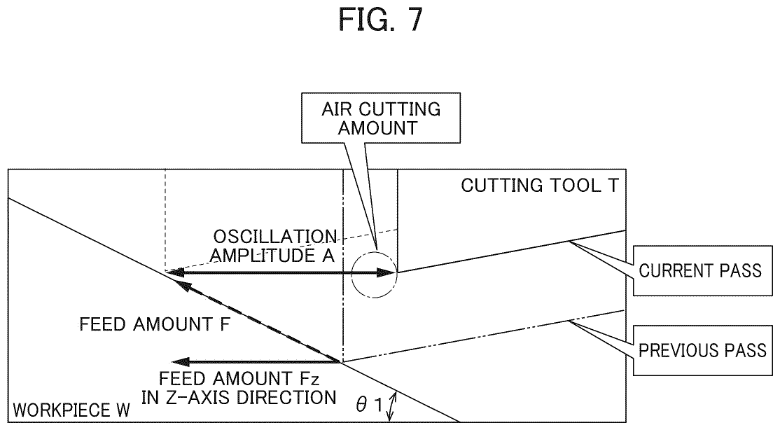

FIG. 7 is a diagram schematically showing a positional relationship between the workpiece and the cutting tool when the taper angle θ1 is small. In the example illustrated in FIG. 7, since the taper angle θ1 is small, even if Fz, which is the velocity component in the Z-axis direction of the feed amount F, is calculated by way of geometric calculation, the velocity component Fz in the Z-axis direction of the feed amount F is substantially the same as the feed amount F because F≈Fz is satisfied. For example, even when F=a feed amount of 0.1 [mm/rev], Fz can be set to 0.1 [mm/rev]. In this case, Fz=0.1 is substituted as F into Equation (1) so as to calculate the oscillation amplitude A.

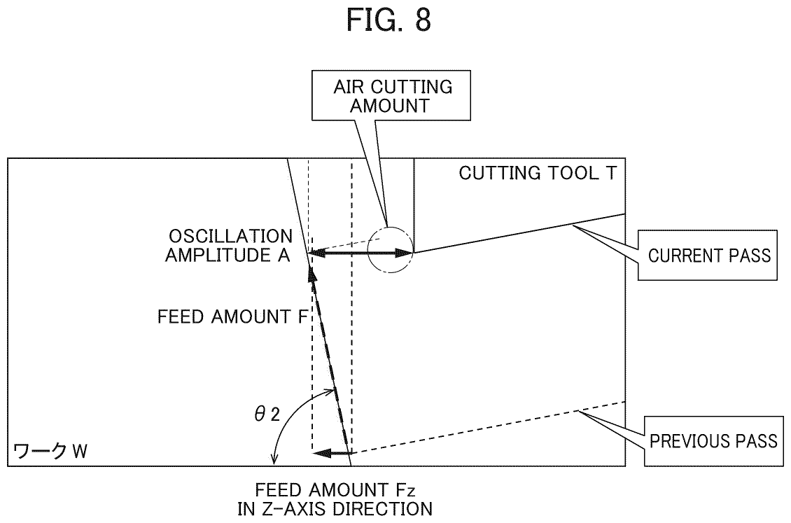

FIG. 8 is a diagram schematically illustrating a positional relationship between the workpiece and the cutting tool when the taper angle is small. In the example illustrated in FIG. 8, since the taper angle θ2 is large, even if Fz is calculated by way of geometric calculation, F≈Fz cannot be satisfied. For example, when F=a feed amount of 0.1 [mm/rev], Fz is 0.01 [mm/rev]. In this case, Fz=0.01 is substituted as F into Equation (1) so as to calculate the oscillation amplitude A.

According to the second embodiment described above, the control device 1 for a machine tool that performs machining while relatively oscillating a cutting tool T and a workpiece W exerts the following effects.

According to the second embodiment, a condition acquisition unit 11a acquires taper information regarding a movement direction and a movement angle of the cutting tool T, and a machining control unit 13a acquires a feed amount (feed amount F) in an oscillation direction based on the taper information and information regarding the feed amount, and determines information that is not acquired by the condition acquisition unit 11a (an oscillation amplitude A) using the feed amount in the oscillation direction. According to the known art, in either of the cases illustrated in FIGS. 6 and 7, an air cutting amount is not designated, and therefore, even if the feed rate is set constant, the feed rate in the Z-axis direction changes, and the result of determination on chip shredding varies. In this respect, the control device 1 of the second embodiment calculates the oscillation amplitude based on a designated air cutting amount, and therefore, even if a taper angle is large and the velocity component in the Z-axis direction is considerably different, it is possible to avoid a situation in which the result of determination on chip shredding varies due to a difference in the taper angle.

### Third Embodiment

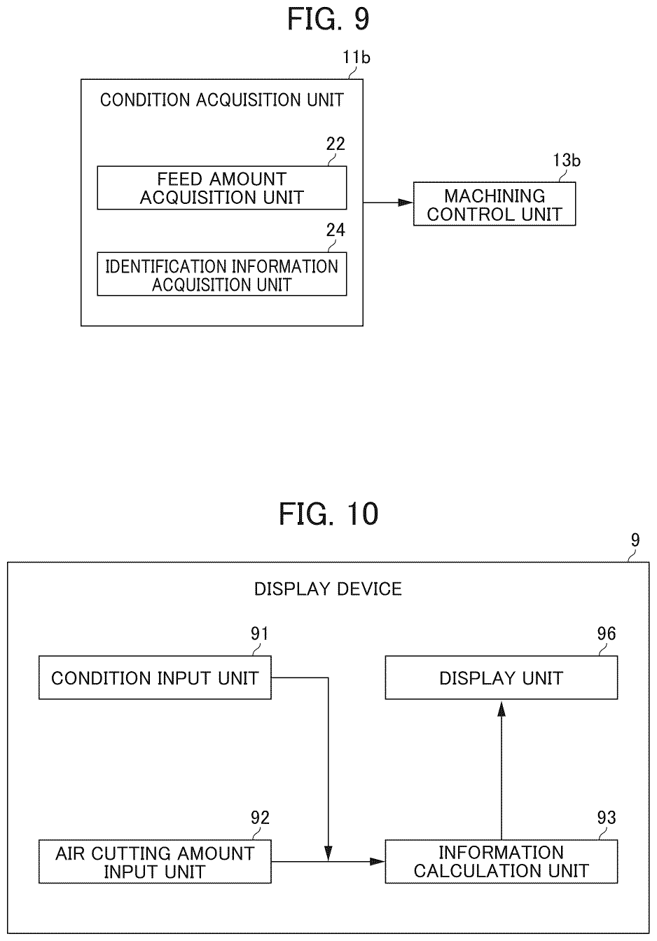

FIG. 9 is a block diagram illustrating conditions acquired by a condition acquisition unit 11b of a third embodiment. The control device 1 according to the third embodiment is the same as the control device 1 for a machine tool according to the first embodiment except for the conditions acquired by the condition acquisition unit 11b and the control method executed by a machining control unit 13b.

As illustrated in FIG. 9, the condition acquisition unit 11b includes a feed amount acquisition unit 22 and an identification information acquisition unit 24.

The identification information acquisition unit 24 acquires, from a storage unit 14, identification information for the machining control unit 13b to identify information regarding the number of oscillations per relative rotation of a cutting tool T and a workpiece W (oscillation frequency multiplying factor I) and an oscillation amplitude with respect to a feed amount per relative rotation of the cutting tool T and the workpiece (oscillation amplitude multiplying factor K). When one of the oscillation frequency multiplying factor I or the oscillation amplitude multiplying factor K is uniquely determined, the other can be calculated according to Equation (1).

Example of the identification information acquired by the identification information acquisition unit 24 will be described below. The identification information may be a designated chip length that indicates a chip length designated by an operator. By setting the designated chip length, the oscillation frequency multiplying factor I can be uniquely determined. Alternatively, the identification information may be a frequency upper limit value. For example, a configuration may be adopted in which the oscillation frequency is set to be always close to the frequency upper limit value, the number of oscillations per rotation of the spindle is fixed to 0.5 as long as the frequency upper limit value is not exceeded, and in a case where the oscillation frequency exceeds the frequency upper limit value, the number of oscillations per rotation of the spindle is reduced until the oscillation frequency decreases to the frequency upper limit value or less. With this configuration, the oscillation frequency multiplying factor I can be identified. Alternatively, the identification information may be a recommended value for the oscillation frequency, and a setting may be made such that operation is carried out at the recommended value, whereby the oscillation frequency multiplying factor I can be uniquely identified.

Alternatively, the identification information may be an upper limit value of the oscillation amplitude and the oscillation amplitude may always be set to the upper limit value, whereby the oscillation amplitude multiplying factor K can be uniquely identified. Alternatively, in a case where the oscillation amplitude multiplying factor K is set as the identification information, and there are a plurality of options of the oscillation frequency multiplying factor I, a setting may be made such that one oscillation frequency multiplying factor I with a small value is selected, whereby the oscillation frequency multiplying factor I for performing the machining control can be uniquely identified.

Alternatively, the identification information may be a lower limit value of the oscillation amplitude, and a setting may be made such that when the amplitude upper limit value is reached while the oscillation frequency multiplying factor I is 1.0 or 0.99, the oscillation frequency multiplying factor I is shifted to be reduced, whereby the oscillation frequency multiplying factor I can be uniquely identified. Alternatively, a designated velocity upper limit value, a designated acceleration upper limit value, a designated jerk upper limit value, or the like may be set as the identification information. Alternatively, control may be performed such that the acceleration becomes the lowest. Furthermore, two or more of the above-described examples of the identification information may be combined. As described above, the identification information is a rule set for the machine tool, and may be any information as long as it allows the machining control unit 13 to identify the information.

In the above-described example, among the three pieces of information, i.e., the feed amount, the oscillation frequency multiplying factor I, and the oscillation amplitude multiplying factor K, the information regarding the feed amount is acquired, and the oscillation frequency multiplying factor I and the oscillation amplitude multiplying factor K are determined based on the designated air cutting amount and the identification information. However, the oscillation frequency multiplying factor I or the oscillation amplitude multiplying factor K may be acquired instead of the feed amount, and the remaining two pieces of information may be determined based on the designated air cutting amount and the identification information.

In that case, the identification information allows the feed rate to be uniquely identified based on an indicator related to a cycle time or an indicator related to a surface roughness.

The machining control unit 13b of the third embodiment determines the oscillation frequency multiplying factor I and the oscillation amplitude multiplying factor K based on the feed amount, the designated air cutting amount, and the identification information.

According to the third embodiment described above, the control device 1 for a machine tool that performs machining while relatively oscillating a cutting tool T and a workpiece W exerts the following effects.

The condition acquisition unit 11b of the third embodiment acquires, as a precondition, information regarding the feed amount from among the three pieces of information, and acquires identification information that indicates a condition for identifying information regarding the number of oscillations or information regarding an oscillation amplitude. The machining control unit 13b determines the information regarding the number of oscillations and the information regarding the oscillation amplitude based on the information regarding the feed amount and the identification information such that the air cutting amount based on the interval between the pass in the n-th rotation and the pass in the rotation subsequent to the n-th rotation becomes equal to the designated air cutting amount. Due to this feature, in the configuration in which the condition acquisition unit 11b acquires the feed amount, the oscillation frequency multiplying factor I and the oscillation amplitude multiplying factor K can be easily identified by using the identification information.

The configuration of the control device 1 of the above-described embodiments can be appropriately modified according to the circumstances by, for example, omitting a part of the functions or adding another function.

In the above embodiments, the machining control units 13, 13a, and 13b each calculate the oscillation amplitude, but may be configured to determine an amplitude multiplying factor instead of the oscillation amplitude. In that case, at a control stage, an amplitude is determined from a feed amount per rotation of the spindle and an amplitude multiplying factor, and the control is performed based on the amplitude.

The machining control unit may be configured to determine information different from the information regarding the oscillation amplitude, depending on the condition acquired by the condition acquisition unit. For example, the condition acquisition unit may acquire the information regarding the number of oscillations and the information regarding the oscillation amplitude, and the machining control unit may determine the information regarding the feed amount based on the information regarding the number of oscillations and the information regarding the oscillation amplitude. Alternatively, the condition acquisition unit may acquire the information regarding the number of oscillations and the identification information for identifying the information regarding a feed amount set for the machine tool and the information regarding the oscillation amplitude, and the machining control unit may determine the information regarding the feed amount and the information regarding the oscillation amplitude based on the information regarding the number of oscillations and the identification information. Alternatively, the condition acquisition unit may acquire the information regarding the oscillation amplitude and the identification information for identifying the information regarding a feed amount set for the machine tool and the information regarding the number of oscillation, and the machining control unit may determine the information regarding the feed amount and the information regarding the number of oscillations based on the information regarding the oscillation amplitude and the identification information. Specific numerical values may be calculated according to Equation (1).

The determination method and calculation method described above are examples, and information necessary for machining control may be calculated by a method different from the method using the above-described mathematical equation.

It should be noted that the present disclosure is not limited to the above-described embodiments, and modifications and improvements within a range in which the object of the present disclosure can be achieved are encompassed in the present disclosure.

In the above embodiments, the present disclosure is applied to the control device for a machine tool, but the present disclosure is not limited thereto. The present disclosure may be applied to a display device for a machine tool.

Here, FIG. 10 is a functional block diagram of a display device 9 for a machine tool according to a modification. As illustrated in FIG. 10, the display device 9 for a machine tool includes a condition input unit 91, an air cutting amount input unit 92, an information calculation unit 93, and a display unit 96.

The condition input unit 91 corresponds to the condition acquisition units 11, 11a, and 11b of the above-described embodiments. Specifically, the condition input unit 91 receives, as a precondition, an input of one or two pieces of information from among three pieces of information including information regarding a feed amount per relative rotation of a cutting tool and a workpiece, information regarding the number of oscillations per relative rotation of the cutting tool and the workpiece, and information regarding an oscillation amplitude with respect to the feed amount per relative rotation of the cutting tool and the workpiece.

The air cutting amount input unit 92 corresponds to the air cutting amount acquisition unit 12 of the above embodiments. Specifically, the air cutting amount input unit 92 receives an input of a designated air cutting amount that indicates a degree of air cutting in an oscillation direction.

The information calculation unit 93 corresponds to a part of the machining control units 13, 13a, and 13b of the above embodiments. Specifically, the information calculation unit 93 calculates, based on the precondition, the information among the three pieces of information that is not received by the condition input unit such that an air cutting amount based on an interval between a pass in an n-th rotation and a pass in a rotation subsequent to the n-th rotation becomes equal to the designated air cutting amount.

The display unit 96 corresponds to the display unit 16 of the above-described embodiments. Specifically, the display unit 96 displays the information calculated by the information calculation unit 93.

The display device 9 for a machine tool having the above-described configuration exerts the same effects as those of the control device 1 for machine tool according to the above-described embodiments.

### EXPLANATION OF REFERENCE NUMERALS

1: Control device for machine tool
11, 11a, 11b: Condition acquisition unit
12: Air cutting amount acquisition unit
13, 13a, 13b: Machining control unit
16: Display unit
9: Display device for machine tool
91: Condition input unit
92: Air cutting amount input unit
93: Information calculation unit
96: Display unit

1. A control device for a machine tool that performs machining while relatively oscillating a cutting tool and a workpiece, the control device comprising:
a condition acquisition unit configured to acquire, as a precondition, one or two pieces of information from among three pieces of information including information regarding a feed amount per relative rotation of the cutting tool and the workpiece, information regarding a number of oscillations per relative rotation of the cutting tool and the workpiece, and information regarding an oscillation amplitude with respect to the feed amount per relative rotation of the cutting tool and the workpiece;
an air cutting amount acquisition unit configured to acquire a designated air cutting amount that indicates a degree of air cutting in an oscillation direction; and
a machining control unit configured to determine, based on the precondition, the information among the three pieces of information that is not acquired by the condition acquisition unit such that an air cutting amount based on an interval between a pass in an n-th rotation and a pass in a rotation subsequent to the n-th rotation becomes equal to the designated air cutting amount, the machining control unit being configured to perform machining control.

2. The control device according to claim 1, wherein
the condition acquisition unit acquires, as the precondition, the information regarding the feed amount and the information regarding the number of oscillations from among the three pieces of information, and
the machining control unit determines the information regarding the oscillation amplitude based on the information regarding the feed amount and the information regarding the number of oscillations such that the air cutting amount based on the interval between the pass in the n-th rotation and the pass in the rotation subsequent to the n-th rotation becomes equal to the designated air cutting amount.

3. The control device according to claim 1, wherein
the condition acquisition unit acquires one of the three pieces of information as the precondition, and acquires identification information that indicates a condition for identifying remaining two pieces of information of the three pieces of information, and
the machining control unit determines the remaining two pieces of information based on the one of the three pieces of information and the identification information such that the air cutting amount based on the interval between the pass in the n-th rotation and the pass in the rotation subsequent to the n-th rotation becomes equal to the designated air cutting amount.

4. The control device according to claim 1, wherein
the condition acquisition unit acquires taper information regarding a movement direction and a movement angle of the cutting tool, and
the machining control unit determines the feed amount using the taper information.

5. A display device for a machine tool that performs machining while relatively oscillating a cutting tool and a workpiece, the display device comprising:
a condition input unit configured to receive, as a precondition, an input of one or two pieces of information from among three pieces of information including information regarding a feed amount per relative rotation of the cutting tool and the workpiece, information regarding a number of oscillations per relative rotation of the cutting tool and the workpiece, and information regarding an oscillation amplitude with respect to the feed amount per relative rotation of the cutting tool and the workpiece;
an air cutting amount input unit configured to receive an input of a designated air cutting amount that indicates a degree of air cutting in an oscillation direction;
an information calculation unit configured to calculate, based on the precondition, the information among the three pieces of information that is not received by the condition input unit such that an air cutting amount based on an interval between a pass in an n-th rotation and a pass in a rotation subsequent to the n-th rotation becomes equal to the designated air cutting amount; and
a display unit configured to display the information calculated by the information calculation unit.

6. The control device according to claim 2, wherein
the condition acquisition unit acquires taper information regarding a movement direction and a movement angle of the cutting tool, and
the machining control unit determines the feed amount using the taper information.

7. The control device according to claim 3, wherein
the condition acquisition unit acquires taper information regarding a movement direction and a movement angle of the cutting tool, and
the machining control unit determines the feed amount using the taper information.
